(19) United States
(12) Patent Application Publication
(10) Pub. No.: US 2024/0121610 A1
(43) Pub. Date: Apr. 11, 2024

(54) METHODS AND SYSTEMS FOR RESTRICTED SERVICE ACCESS BETWEEN NETWORK FUNCTIONS IN WIRELESS NETWORK

(71) Applicant: Samsung Electronics Co., Ltd., Suwon-si, Gyeonggi-do (KR)

(72) Inventors: Rajavelsamy RAJADURAI, Bangalore (IN); Rajendran ROHINI, Bangalore (IN); Varini GUPTA, Bangalore (IN); Nivedya Parambath SASI, Bangalore (IN)

(21) Appl. No.: 18/276,191

(22) PCT Filed: Feb. 14, 2022
(86) PCT No.: PCT/KR2022/002146

§ 371 Date: Aug. 7, 2023

(30) Foreign Application Priority Data
Feb. 15, 2021 (IN) 202141006313
Feb. 8, 2022 (IN) 2021 41006313

(51) Int. Cl. H04W 12/084

(52) U.S. Cl. CPC H04W 12/084

(57) ABSTRACT

The disclosure relates to a 5G or 6G communication system for supporting a higher data transmission rate. Embodiments herein disclose a method for providing restricted service access in a wireless network by a first network entity (i.e., target AMF entity (400)). The method includes requesting a NRF entity (600) to grant an access-token to access a second network entity (i.e., initial AMF entity (300)). Further, the method includes receiving a message comprising a restricted service access to the second network entity based on the access-token. Further, the method includes sending a restricted UE context transfer request to the second network entity based on the message comprising the restricted service access. Further, the method includes receiving a UE context transfer response from the second network entity based on the restricted UE context transfer request.

### TECHNICAL FIELD

Embodiments disclosed herein relate to a wireless network, and more specifically related to methods and systems for restricted service access between network functions in the wireless network (e.g., Fifth Generation (5G) networks).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service. Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The currently solution or any future solution may require either N14 interface or any well-connected network to act as a middle node for sharing security context between two AMFs belonging to different slices. It is not clear exactly what amount of information could be shared by the initial AMF to the target AMF.

In other words, the said target AMF should not be allowed with complete access to the security context or any other service from the said initial AMF (required for AMF re-allocation).

Therefore, for addressing this issue there should be a method and system to provide restricted service to the AMF requesting for security context or any other security related information.

### Solution to Problem

Accordingly, the embodiments herein provide methods for providing restricted service access in a wireless network. The method includes requesting, by a first network entity, a Network Repository Function (NRF) entity to grant an access-token to access a second network entity. Further, the method includes receiving, by the first network entity, a message comprising a restricted service access to the second network entity based on the access-token. Further, the method includes sending, by the first network entity, a restricted User Equipment (UE) context transfer request to the second network entity based on the message comprising the restricted service access. Further, the method includes receiving, by the first network entity, a UE context transfer response from the second network entity based on the restricted UE context transfer request.

In an embodiment, the restricted service access includes at least one of a UE context transfer access, a registration status update access, and a create UE context access.

In an embodiment, the first network entity requests for the restricted service access from the second network entity in a mobility registration scenario.

In an embodiment, the first network entity is a target AMF entity and the second network entity is an initial AMF entity.

In an embodiment, the NRF entity generates an access token scope for restricted Security context transfer between the first network entity and the second network entity.

In an embodiment, the access token scope restricts a permission granularity, and a scope associated with the first network entity indicates a permission as READ only to avoid force writing of security context to the first network entity.

Accordingly, the embodiments herein provide a first network device for providing restricted service access in a wireless network. The first network device includes a restricted service access controller coupled with a processor and a memory. The restricted service access controller is configured to request a NRF entity to grant an access-token to access a second network entity. Further, the restricted service access controller is configured to receive a message comprising a restricted service access to the second network entity based on the access-token. Further, the restricted service access controller is configured to send a UE context transfer request to the second network entity based on the message comprising the restricted service access. Further, the restricted service access controller is configured to receive a UE context transfer response from the second network entity based on the UE context transfer request.

### Advantageous Effects of Invention

The principal object of the embodiments herein is to disclose methods and systems for providing restricted service access between network functions in a wireless network (e.g., 5G system or the like) by providing an AMF reallocation procedure.

Another object of the embodiments herein is to disclose methods and systems for allowing the consumer NF (i.e., target AMF) to have restricted access to producer NF (i.e., initial AMF). This solution will be applied for both cases when there is N14 interface or there is a well-connected NF.

Another object of the embodiments herein is to disclose methods and systems for restricting the NF producer from force writing the security context on NF consumer i.e., presenting the security context in READ only mode.

Another object of the embodiments herein is to disclose methods and systems for providing authorization between both NF producer and NF consumer. This is achieved by using OAuth framework where the NF consumer is provided with an access token with restricted scope.

Another object of the embodiments herein is to have a separate dedicated interface N14 for the restricted service access between two network functions.

Another object of the embodiments herein is to ensure to provide restricted service access to the AMF requesting for security context or any other security related information.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts different cases of communicating AMFs in an AMF re-allocation scenario (solid line means that there is a N14 interface);

FIG. 2 illustrates a procedure where a target AMF requests for a restricted service access from an initial AMF in case of an initial registration, wherein the initial AMF authorizes the target AMF before sending restricted services parameters in a response message, according to embodiments as disclosed herein;

FIG. 3 illustrates the procedure where the target AMF requests for a restricted service access from an initial AMF in case of a mobility registration, wherein the initial AMF authorizes the target AMF before sending the restricted services parameters in the response message, according to embodiments as disclosed herein;

FIG. 4 illustrates a procedure in which the target AMF requests for a restricted service access from an old AMF in case of a mobility registration, wherein the old AMF authorizes the target AMF before sending the restricted services parameters in the response message, according to embodiments as disclosed herein;

FIG. 5 illustrates a procedure in which the target AMF requests for a restricted service access from an initial AMF in case of a mobility registration, wherein the initial AMF authorizes the target AMF before sending the restricted services parameters in the response message, according to embodiments as disclosed herein;

FIG. 6 illustrates a procedure in which the target AMF requests for a restricted service access from the initial AMF in case of mobility registration, wherein the initial AMF authorizes the target AMF before sending the restricted services parameters in the response message, according to embodiments as disclosed herein;

FIG. 7 illustrates the procedure of OAuth framework where a NRF acts as the OAuth Server used for getting an Access token by a NF consumer to get the security context from a NF producer, according to embodiments as disclosed herein;

FIG. 8 illustrates the procedure of OAuth framework where trusted AF acts as the OAuth server used for getting an access token by the NF consumer to get the security context from the NF producer, according to embodiments as disclosed herein;

FIG. 9 illustrates the procedure of OAuth framework where AUSF/UDM acts as the OAuth server used for getting an access token by the NF consumer to get the security context from the NF producer, according to embodiments as disclosed herein;

FIG. 10 shows various hardware components of a first network entity/target AMF entity, according to embodiments as disclosed herein; and

FIG. 11 is a flow chart illustrating a method, implemented by the target AMF entity, for providing restricted service access in a wireless network, according to embodiments as disclosed herein.

### MODE FOR THE INVENTION

The 5G system supports a registration procedure with Access and Mobility Management Function (AMF) re-allocation. As described in technical specification (TS) 23.502, this procedure is used when an initial AMF is unable to serve a User Equipment (UE). In which case, a Non-access stratum (NAS) message received from the UE is rerouted to another target AMF either directly over the AMF-to-AMF interface i.e., N14, or via a Radio Access Network (RAN). Currently, the reroute via the RAN is only possible during an initial registration. Once the UE has been registered and established security with a wireless network, only the direct reroute is possible. The reason for this is that the current security mechanisms specified in the TS 33.501 rely heavily on the assumption that the AMFs can communicate directly over the N14 interface.

The dependency on this assumption goes to the extent that the security specifications prohibit the UE from accepting unprotected messages from the core, once security has been established. Therefore, whilst a registered UE is moving from an area to the other, it is assumed that the target AMF is always able to retrieve the security context from an old AMF or the initial AMF that used to serve the UE. In case, a reroute via the RAN takes place, and the target AMF is unable to retrieve the UE security context, then the target AMF is not able to trigger a new authentication procedure in order to establish a new security context. In fact, the target AMF wouldn't be able to communicate with the UE in the first place, since all the unprotected downlink messages will be dismissed by the UE.

The key issue captured in the TR 33.864 is to address the security handling of the AMF re-allocation procedure upon a UE registration with slicing requirements. The AMF re-allocation procedure, due to slicing, may involve more than one AMFs which may be isolated with each other due to deployment requirements. The TS 23.502 includes two cases of the re-allocation procedure, the direct case and the indirect case. The security handling of the direct case is specified in the TS 33.501 and the security handling of the indirect case is the objective of this key issue.

According to the specified AMF re-allocation procedure, when an initial AMF receives a registration request, the initial AMF may need to reroute the registration request to another target AMF, e.g., when the initial AMF is not the appropriate AMF to serve the UE. The initial AMF may not be connected to the target AMF. One option for the AMF re-allocation is to reroute the AMF registration request through the RAN, i.e., the initial AMF (that is, the AMF receiving the registration request message) will send the registration request to the RAN, and the RAN will then forward the registration request to the target AMF.

In the indirect case of AMF re-allocation, the UE registration request is transferred from the initial AMF to the target AMF through the RAN, due to the lack of connectivity between the initial AMF and the target AMF.

However, the existing security handling for this case may lead to consistent registration failure which threatens the availability of the wireless network. More specifically, if the initial AMF and the UE have securely exchanged NAS messages, the UE will reject the NAS message from the target AMF, due to the potential lack of access to the UE security context by the target AMF or due to inconsistent security context used by the target AMF. Inconsistent security context usage by the target AMF happens when the target AMF retrieves a security context from the old AMF, and it does not match the new security context used by the UE, as the UE has established new security context with the initial AMF. This impact the UE service availability (i.e., leading to registration failure and service failure).

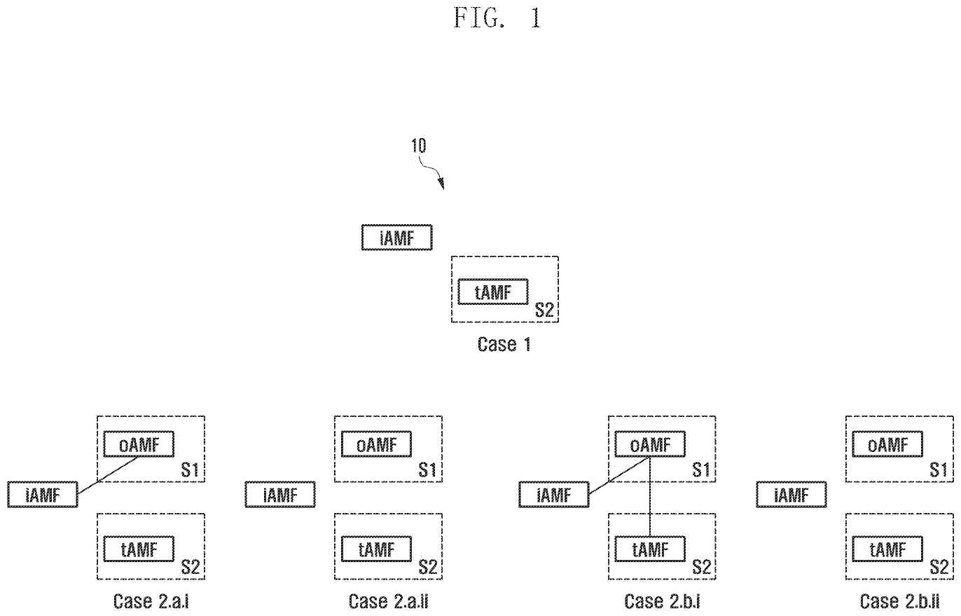

The UE may have been registered in the past to an old AMF (oAMF). It is assumed that the UE initiates a new registration request and this request is currently handled by the initial AMF (iAMF). The UE provides protected slice selection information (NSSAI) either in a protected registration request message if it shares a security context with the network (i.e., oAMF) or after security is established with the iAMF in case of initial registration. As a result, for the iAMF to determine whether it can handle the UE registration, the iAMF may need to retrieve any existing security context from the oAMF or establish new security with the UE. It is assumed that the iAMF does not have a communication interface (e.g., N14) to the tAMF. The iAMF may or may not have a communication interface to the oAMF. The tAMF may or not have a communication interface to the oAMF. The different cases (10) of connectivity among iAMF, tAMF, oAMF are depicted in the FIG. 1 and described below. The absence of communication interfaces is assumed to be due to isolation requirements on the AMFs or deployment restrictions.

The problem of AMF re-allocation via the RAN includes two cases. In both cases the iAMF and the tAMF do not have any communication interface such as N14 between them as specified in the TS 23.502, clause 4.2.2.2.3. The two cases are the following:

1. Initial registration: The UE performs an initial registration providing a Subscription Concealed Identifier (SUCIP). The UE potentially interacts only with the iAMF and the tAMF. In order for the iAMF to determine if there is an AMF re-allocation, the iAMF needs to establish security with the UE and the UE needs to send the complete registration request including the protected IEs (such as the NSSAI) to the iAMF. After security is established between the UE and the network the UE does not accept any unprotected NAS messages according to TS 24.501, clause 4.4.4.2.

2. Mobility Registration Update: The UE has established security with the oAMF in the last registration. In this case, the AMF re-allocation procedure may involve the iAMF, the oAMF and the tAMF. There are the following four subcases in this case:
a. The oAMF does not share any direct communication interface with the tAMF
i. The iAMF and the oAMF can communicate directly.
ii. The iAMF and the oAMF do not have any direct communication interface between them.
b. The oAMF shares a direct communication interface with the tAMF.
i. The iAMF and the oAMF can communicate directly.
ii. The iAMF and the oAMF do not have any direct communication interface between them.

FIG. 1 depicts different cases of communicating AMFs (solid line means that there is a N14 interface).

Currently, there are some solutions captured in the TR 33.864 to resolve the AMF re-allocation issue. However, the solutions make several assumptions such as having a shared network function or impact of having KAMF key with the RAN or the handling of unprotected messages which indirectly compromises the security requirement about isolation of network slices and security risk of accepting unprotected messages or impact on the existing procedure which violates the current agreements/rational.

However, the currently captured solution or any future solution may require either N14 interface or any well-connected network to act as a middle node for sharing security context between two AMFs belonging to different slices. It is not clear exactly what amount of information could be shared by said initial AMF to the said target AMF.

In other words, the said target AMF should not be allowed with complete access to the security context or any other service from the said initial AMF (required for AMF re-allocation).

Therefore, for addressing this issue there should be a method and system to provide restricted service to the AMF requesting for security context or any other security related information.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for providing restricted service access in a wireless network. The method includes requesting, by a first network entity, a NRF entity to grant an access-token to access a second network entity. Further, the method includes receiving, by the first network entity, a message comprising a restricted service access to the second network entity based on the access-token. Further, the method includes sending, by the first network entity, a restricted UE context transfer request to the second network entity based on the message comprising the restricted service access. Further, the method includes receiving, by the first network entity, a UE context transfer response from the second network entity based on the restricted UE context transfer request.

The proposed methods and systems can be used for allowing the consumer NF (e.g., target AMF) to have restricted access to producer NF (e.g., initial AMF). This solution will be applied for both cases when there is N14 interface or there is a well-connected NF. The proposed methods and systems can be used for restricting the NF producer from force writing the security context on NF consumer i.e., presenting the security context in READ only mode.

The proposed methods and systems can be used for providing authorization between both NF producer and NF consumer. This is achieved by using OAuth framework where NF consumer is provided with an access token with restricted scope. The proposed method provides a separate dedicated interface N14 for the restricted service access between two network functions.

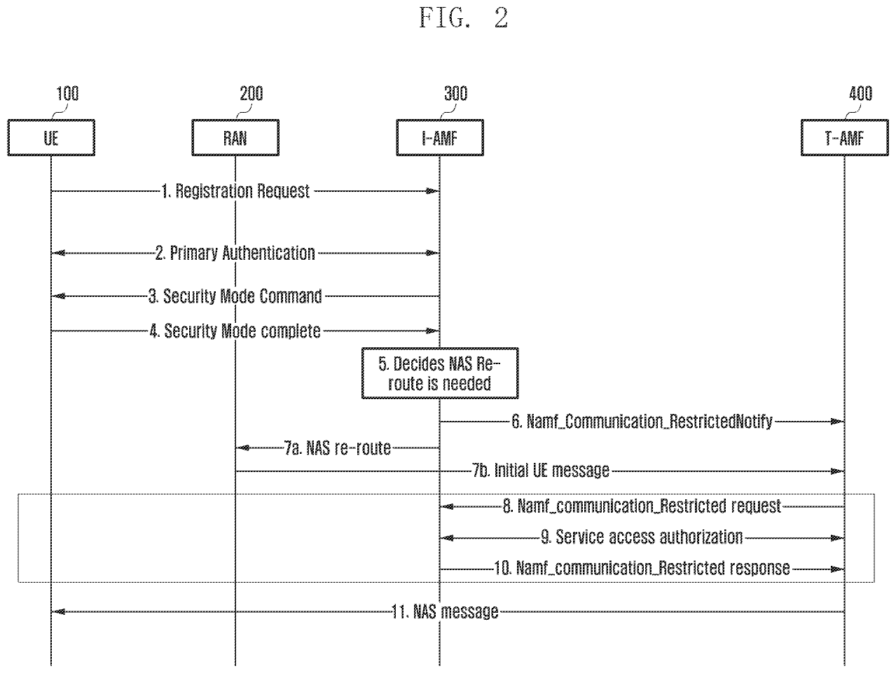

Referring now to the drawings, and more particularly to FIGS. 2 through 11, where similar reference characters denote corresponding features consistently throughout the figures, there are shown at least one embodiment.

The term “NF consumer” has been used interchangeably for initial AMF (in case of getting restricted service access from an old AMF) or target AMF throughout this document only for AMF re-allocation scenario.

The term “NF producer” has been used interchangeably for initial AMF (in case of providing restricted service access to target AMF) or the old AMF throughout this document only for AMF re-allocation scenario.

Restricted Service:

In an embodiment, a new restricted service for peer AMF communication is defined.

The AMFs which belong to isolated slices are only allowed to communicate with each other using this service.

The term “target AMF (tAMF)” implies that AMF which will be isolated from the other specific AMFs, as tAMF is serving some critical slice, for example, Mission Critical services. In an embodiment, tAMF will have restriction in providing the context to other AMFs and is only allowed to receive the context.

The term “old AMF (oAMF) and initial AMF (iAMF)” implies that AMF will be servicing certain slice and will not be allowed to request UE context from the tAMF.

The tAMF may or may not have a communication interface to the oAMF. The tAMF have a communication interface with the iAMF.

As an illustration, restricted service is defined as a Namf_Communication Restricted service, and supports following service operations:
1. UEContextTransfer,
2. RegistrationStatusUpdate, and
3. CreateUEContext

Tables 1-3 illustrate what kind of operations are allowed among the tAMF, the iAMF and the oAMF using the service:

Table 1 provides the list of tAMF restricted services for o/i AMF.

TABLE 1

| | | Operation | Example |
|---|---|---|---|
| Service Name | Service Operations | Semantics | Consumer(s) |
| Namf_Communi- | UEContextTransfer | Request | o/i AMF |
| cation_Restricted | | | |
| | RegistrationStatusUpdate | Request | o/i AMF |
| | CreateUEContext | Response | o/i AMF |

Table 2 depicts the list of oAMF/iAMF restricted services for tAMF.

TABLE 2

| | | Operation | Example |
|---|---|---|---|
| Service Name | Service Operations | Semantics | Consumer(s) |
| Namf_Communi- | UEContextTransfer | Response | tAMF |
| cation_Restricted | | | |
| | RegistrationStatusUpdate | Response | tAMF |
| | CreateUEContext | Request | tAMF |

Table 3 illustrates, as an example, the limited information that can be exchanged between AMFs which communicate with each other using such restricted service. Table 3 depicts the definition of type UEContext Restricted.

TABLE 3

| | | | Cardi- | |
|---|---|---|---|---|
| Attribute name | Data type | P | nality | Description |
| Supi | Supi | C | 0 . . . 1 | This IE shall be |
| | | | | present if available. |
| | | | | When present, this |
| | | | | IE contains SUPI of |
| | | | | the UE. |
| supiUnauthInd | boolean | C | 0 . . . 1 | This IE shall be |
| | | | | present if SUPI is |
| | | | | present. When |
| | | | | present, it shall |
| | | | | indicate whether |
| | | | | the SUPI is |
| | | | | unauthenticated. |
| udmGroupId | NfGroupId | O | 0 . . . 1 | When present, it |
| | | | | shall indicate the |
| | | | | identity of the |
| | | | | UDM Group |
| | | | | serving the UE. |
| ausfGroupId | NfGroupId | O | 0 . . . 1 | When present, it |
| | | | | shall indicate the |
| | | | | identity of the |
| | | | | AUSF Group |
| | | | | serving the UE. |
| pcfGroupId | NfGroupId | O | 0 . . . 1 | When present, it |
| | | | | shall indicate the |
| | | | | identity of the |
| | | | | PCF Group |
| | | | | serving the UE. |
| routingIndicator | string | O | 0 . . . 1 | When present, it |
| | | | | shall indicate the |
| | | | | Routing Indicator |
| | | | | of the UE. |
| seafData | SeafData | C | 0 . . . 1 | This IE shall be |
| | | | | present if available |
| | | | | and if it is not case |
| | | | | b) specified in TS |
| | | | | 29.518, |
| | | | | clause 5.2.2.2.1.1 |
| | | | | step 2a or the case |
| | | | | specified in TS |
| | | | | 29.518 |
| | | | | clause 5.2.2.2.1.2. |
| | | | | When present, this |
| | | | | IE contains the |
| | | | | security data |
| | | | | derived from data |
| | | | | received from |
| | | | | AUSF of the UE. |
| 5gMmCapability | 5GMmCapability | C | 0 . . . 1 | This IE shall be |
| | | | | present if the UE |
| | | | | had provided this |
| | | | | IE during Regis- |
| | | | | tration Procedure |
| | | | | and if it is not case |
| | | | | b) specified in TS |
| | | | | 29.518, |
| | | | | clause 5.2.2.2.1.1 |
| | | | | step 2a. When |
| | | | | present, this IE |
| | | | | shall contain 5G |
| | | | | MM capability of |
| | | | | the UE. |
| pcfId | NfInstanceId | C | 0 . . . 1 | This IE shall be |
| | | | | present if available |
| | | | | and if it is not case |
| | | | | b) specified in TS |
| | | | | 29.518 |
| | | | | clause 5.2.2.2.1.1 |
| | | | | step 2a. When |
| | | | | present, this IE |
| | | | | indicates the |
| | | | | identity of the |
| | | | | PCF for AM |
| | | | | Policy and/or UE |
| | | | | Policy. |
| pcfSetId | NfSetId | C | 0 . . . 1 | This IE shall be |
| | | | | present, if |
| | | | | available. When |
| | | | | present, it shall |
| | | | | contain the NF Set |
| | | | | ID of the PCF for |
| | | | | AM Policy and/or |
| | | | | UE Policy. |
| pcfAmpSer- | NfServiceSetId | C | 0 . . . 1 | This shall be |
| viceSetId | | | | present, if |
| | | | | available. When |
| | | | | present, it shall |
| | | | | contain the NF |
| | | | | Service Set ID of |
| | | | | the PCF's AM |
| | | | | Policy service. |
| pcfUepSer- | NfServiceSetId | C | 0 . . . 1 | This shall be |
| viceSetId | | | | present, if |
| | | | | available. When |
| | | | | present, it shall |
| | | | | contain the NF |
| | | | | Service Set ID of |
| | | | | the PCF's UE |
| | | | | Policy service. |
| pcfBindingLevel | SbiBindingLevel | C | 0 . . . 1 | This IE shall be |
| | | | | present if |
| | | | | available. When |
| | | | | present, this IE |
| | | | | shall contain the |
| | | | | SBI binding level |
| | | | | of the PCF's AM |
| | | | | policy and UE |
| | | | | Policy association |
| | | | | resources. |
| pcfAmPolicyUri | Uri | C | 0 . . . 1 | This IE shall be |
| | | | | present if available |
| | | | | and if it is not case |
| | | | | b) specified in TS |
| | | | | 29.518 |
| | | | | clause 5.2.2.2.1.1 |
| | | | | step 2a. When |
| | | | | present this IE |
| | | | | shall contain the |
| | | | | URI of the in- |
| | | | | dividual AM |
| | | | | policy resource |
| | | | | (see 3GPP TS |
| | | | | 29.507, clause |
| | | | | 5.3.3.2) used by |
| | | | | the AMF. |

FIG. 2 illustrates a procedure in which the target AMF (400) requests for a restricted service access from initial AMF (300) in case of initial registration, wherein the initial AMF (300) authorizes the target AMF (400) before sending the restricted services parameters in the response message.

Step 1: The UE (100) sends a registration request with a SUCI.

Step 2: Since it is an initial registration, the initial AMF (300) initiates a primary authentication. The initial AMF (300) performs a round of primary authentication with the UE (100) to establish new security context. In an embodiment, in order for the iAMF (300) to determine if there is an AMF re-allocation, the iAMF (300) needs to establish security with the UE (100) and the UE (100) needs to send the complete registration request including the protected IEs (such as the NSSAI) to the iAMF (300).

Step 3: The initial AMF (300) sends a security mode command (SMC) message if decides to take into use the new security context resulted from the successful authentication.

Step 4: The UE (100) processes the security mode command (SMC) message and returns a security mode complete message.

Step 5: The initial AMF (300) determines the need of AMF re-allocation, finds the suitable target AMF (400) to be re-allocated to and decides to initiate NAS rerouting based on local policy and subscription information.

Step 6: (Optional) The initial AMF (300) notifies the target AMF (400) about the restricted service access.

Step 7a: If the UE (100) and the initial AMF (300) have activated security context, the initial AMF (300) sends a NAS re-route message to the RAN (200) with indication of AMF re-allocation.

In an embodiment, along with the indication the initial AMF (300) may include the AMF ID (which identifies the initial AMF). In an embodiment, the initial AMF (300) sends an indication of NAS re-route to the UE (100) in a NAS message. This indication is sent in order to notify the UE (100) about the decision of NAS re-route.

Step 7b: The RAN (200) re-routes the initial UE message to the appropriate target AMF (400).

Step 8: On receiving the initial registration request via the NAS re-route, the target AMF (400) requests for the restricted service from the initial AMF (300) in a service-based message (i.e., Namf_communication_Restricted request).

Step 9: The target AMF (400) sends a service access request to an OAuth server, the Network Repository Function (600) (as defined in clause 5.7)/Trusted 3 rd Party Application Function (as defined in clause 5.8)/Authentication Server Function or UDM (as defined in clause 5.7) which acts as a token issuer for the restricted access service.

In case, the OAuth Server is a trusted 3rd party entity, it is assumed that there is a mutual authentication between the AMF and the AF before the exchange of any tokens. In an embodiment, the target AMF (400) constructs the request for service access may include the parameters, as depicted in Table 4.

TABLE 4

| Parameter | Presence | Values |
|---|---|---|
| Ser- | RE- | For the AMF re-allocation purpose the service |
| vice_type | QUIRED | type is set as: “AMF-Relloc: RestrictedAccess”, |
| | | which indicates about the restricted service |
| | | for which the access token is requested for. |
| NF | RE- | The identifier of the AMF making the request |
| Consumer | QUIRED | to which the AF will redirect the service |
| ID | | access response in order to return the |
| | | authorization code. |
| Scope | RE- | Scope values are expressed as a list of |
| | QUIRED | space-delimited, case-sensitive strings |
| | | which indicate which indicates about the |
| | | restricted service. If authorized, the |
| | | requested scope values will be bound to |
| | | the access token returned to the NF |
| | | consumer (target AMF in this case). |
| NF | OP- | The identifier of the AMF from which the |
| Producer | TIONAL | restricted service access will be requested. |
| ID | | |

Alternatively, upon receiving initial registration request via the NAS re-route, the target AMF (400) first determines which services are supported by the initial AMF (300) by querying the NRF entity (600). It then sends a service-access request to authorization server requesting access to the initial AMF's services which provide UE context transfer service.

On successful authorization check, the NRF (600)/AF/AUSF or UDM (700) provides an access token and ServID token scoped only for getting the restricted service (security context) from the initial AMF (300).

Alternatively, based on the information about the target AMF (400) received during the access token request in Step 9, the NRF (600) determines that it is only allowed to access restricted services on the initial AMF (300). Accordingly, it returns an access token with scope limited to restricted services only, irrespective of what was requested in the request.

In an embodiment, there is only one access token generated scope of which also helps to identify the restricted service. In another embodiment, the NRF (600)/AF/AUSF or UDM (700) generates two tokens, one access token scoped only for identification of NF consumer and another service token (ServID Token) scoped to identify the restricted service for which the access token is being issued.

The access token is used to get the security context from the initial AMF (300). ServID Token is associated with Access token; it helps to associate with the AMF from which the context is being requested.

In an embodiment, the core network provides only one access token which is used by the NF consumer encoded as a JSON Web Token. In an embodiment, the access token provided by OAuth Server allows access to only the restricted service(s) and/or restricted service operation(s).

In another embodiment, the core network issues two tokens, one access token scoped only for identification of NF consumer and another service token (ServID Token) scoped to identify the restricted service for which the access token is being issued.

Table 5 illustrates the claims conveyed using the access token.

TABLE 5

| Parameter | Presence | Description |
|---|---|---|
| Exp | Required | Expiry time of token |
| Scope | Required | A JSON string containing a space-separated |
| | | list of the restricted authorization scopes |
| | | associated with the access token. NOTE: The |
| | | scope is open to all restricted services, but |
| | | this document only includes the restricted |
| | | scope as Security context transfer. |
| NF | Required | The identifier of the NF consumer making |
| consumer_ID | | the request for token. NOTE: This parameter |
| | | is used to identify the AMF which will be |
| | | requesting for the security context from |
| | | the other AMF. |

NOTE:
The claims are not restricted to above described parameters.

Step 10: On receiving access token(s), the target AMF (400) sends a Namf_Communication_UEContextTransfer Request, or to the restricted service and/or operation as indicated by access token, to the initial AMF (300). The initial AMF (300) being pre-provisioned with the tokens performs a token validation with the pre-provisioned token or with NRF (600)/AF/AUSF or UDM (700). On successful validation of tokens, the initial AMF (300) sends the security context in possession (which is also in possession with the UE) to the target AMF (400) in the Namf_Communication_Rsestricted response message.

In an embodiment, the target AMF (400) indicates or sets the permission as READ ONLY. Therefore, the initial AMF (300) is only allowed to provide the security context to the target AMF (400) avoiding the force writing of security context to the target AMF (400).

Alternatively, step 9 can be performed before step 8.

Step 11: With the received security context the target AMF (400) sends the protected NAS message and UE (100) being in possession with the same security context is able to process the NAS messages from target AMF (400).

In order to protect against leakage or other compromise, access token lifetimes are typically short lived. Some access tokens can be issued longer-lived refresh tokens, which enable them to refresh the access token and avoid having to prompt the user for authentication again when the access token expires. Refresh tokens are available only to AMF utilizing the authorization code.

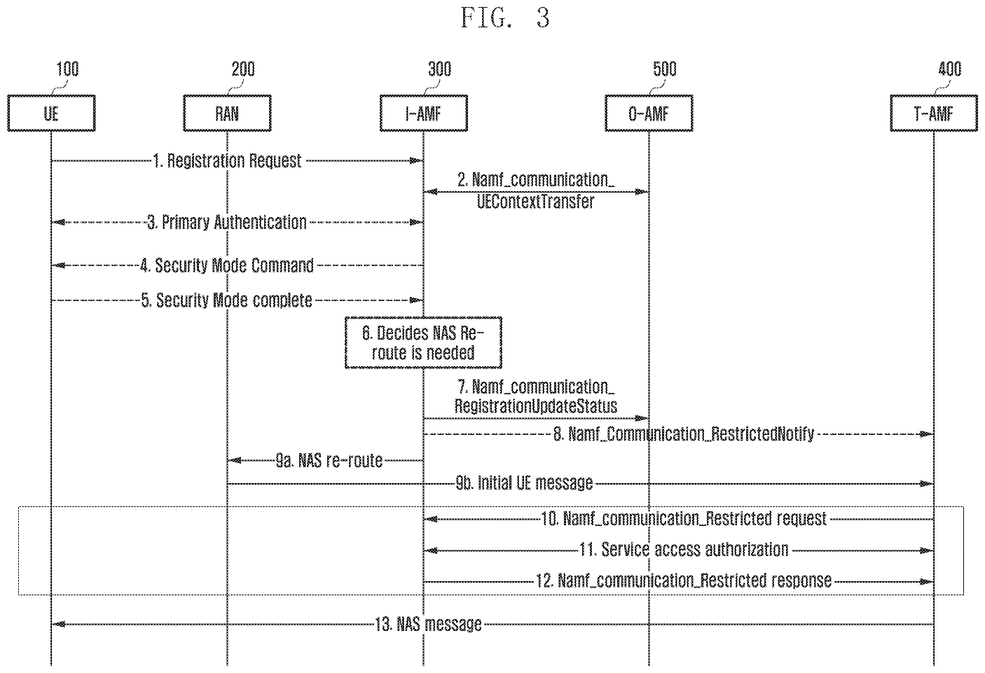

FIG. 3 illustrates the procedure in which the target AMF (400) requests for the restricted service access from the initial AMF (300) in case of mobility registration, wherein the initial AMF (300) authorizes the target AMF (400) before sending the restricted services parameters in the response message.

Step 1: The UE (100) sends a registration request with a SUCI or 5G-GUTI.

Step 2: Since it is a mobility registration the initial AMF (300) gets the security context from an old AMF (500).

Step 3: If it is an initial registration, the initial AMF (300) initiates primary authentication. The initial AMF (300) performs a round of primary authentication with the UE (100) to establish new security context.

In an embodiment, in order for the iAMF (300) to determine if there is an AMF re-allocation, the iAMF (300) needs to establish security with the UE (100) and the UE (100) needs to send the complete registration request including the protected IEs (such as the NSSAI) to the iAMF (300).

Step 4: The initial AMF (300) sends a security mode command (SMC) message if decides to take into use the new security context resulted from the successful authentication.

Step 5: The UE (100) processes the security mode command (SMC) message and returns a security mode complete message.

Step 6: The initial AMF (300) determines the need of AMF re-allocation, finds the suitable target AMF (400) to be re-allocated to and decides to initiate NAS rerouting based on local policy and subscription information.

Step 7: If step 2 is not performed, this step is skipped. Otherwise, the initial AMF (300) notifies the old AMF (500) that the registration is not successful. The old AMF (500) continues as if the Namf_Communication_UEContextTransfer in step 2 had never been received.

Step 8: (Optional) The initial AMF (300) notifies the target AMF (400) as well as the old AMF (500) about the restricted service access.

Step 9a: If the UE (100) and the initial AMF (300) have activated security context, the initial AMF (300) sends a NAS re-route message to the RAN (200) with indication of AMF re-allocation.

In an embodiment, along with the indication the initial AMF (300) may include the AMF ID (which identifies the initial AMF). In an embodiment, the initial AMF (300) sends an indication of NAS re-route to the UE (100) in a NAS message. This indication is sent in order to notify the UE about the decision of NAS re-route.

Step 9b: The RAN (200) re-routes the initial UE message to the appropriate target AMF (400).

Step 10: On receiving the initial registration request via NAS re-route, the target AMF (400) requests for the restricted service from the initial AMF (300) in a service based message (e.g., Namf_communication_Restricted request).

Step 11: The target AMF (400) sends a service access request to an OAuth Server, Network Repository Function (600) (as defined in clause 5.7)/Trusted 3 rd Party Application Function (as defined in clause 5.8)/Authentication Server Function or UDM (as defined in clause 5.7) which acts as a token issuer for the restricted access service.

In case the OAuth Server is a trusted 3rd party entity, it is assumed that there is a mutual authentication between AMF and AF before the exchange of any tokens.

In an embodiment, the target AMF (400) constructs the request for service access may include the parameters, as depicted in Table 6.

TABLE 6

| Parameter | Presence | Values |
|---|---|---|
| Ser- | RE- | For the AMF re-allocation purpose the service |
| vice_type | QUIRED | type is set as: “AMF-Relloc: RestrictedAccess”, |
| | | which indicates about the restricted service |
| | | for which the access token is requested for. |
| NF | RE- | The identifier of the AMF making the request |
| Consumer | QUIRED | to which the AF will redirect the service |
| ID | | access response in order to return the |
| | | authorization code. |
| Scope | RE- | Scope values are expressed as a list of space- |
| | QUIRED | delimited, case-sensitive strings which indicate |
| | | which indicates about the restricted service. |
| | | If authorized, the requested scope values will |
| | | be bound to the access token returned to the |
| | | NF consumer (target AMF in this case). |
| NF | OP- | The identifier of the AMF from which the |
| Producer | TIONAL | restricted service access will be requested. |
| ID | | |

Alternatively, upon receiving the initial registration request via the NAS re-route, the target AMF (400) first determines which services are supported by the initial AMF (300) by querying the NRF (600). It then sends a service-access request to authorization server requesting access to the initial AMF's services which provide the UE context transfer service.

On successful authorization check, the NRF (600)/AF/AUSF or UDM (700) provides an access token and ServID token scoped only for getting the restricted service (security context) from the initial AMF (300).

Alternatively, based on the information about the target AMF (400) received during access token request in Step 10, the NRF (600) determines that it is only allowed to access restricted services on the initial AMF (300). Accordingly, it returns an access token with scope limited to restricted services only, irrespective of what was requested in the request.

In an embodiment, there is only one access token generated scope of which also helps to identify the restricted service.

In an embodiment, the NRF (600)/AF/AUSF or UDM (700) generates two tokens, one access token scoped only for identification of NF consumer and another service token (ServID_Token) scoped to identify the restricted service for which the access token is being issued.

The access token is used to get the security context from the initial AMF (300). ServID_Token is associated with the access token, it helps to associate with the AMF from which the context is being requested.

In an embodiment, the core network provides only one access token which is used by the NF consumer encoded as a JSON Web Token. In an embodiment, the access token provided by OAuth Server allows access to only the restricted service(s) and/or restricted service operation(s).

In another embodiment, the core network issues two tokens, one access token scoped only for identification of NF consumer and another service token (ServID_Token) scoped to identify the restricted service for which the access token is being issued.

Table 7 illustrates the claims conveyed using the access token.

TABLE 7

| Parameter | Presence | Description |
|---|---|---|
| Exp | Required | Expiry time of token |
| Scope | Required | A JSON string containing a space-separated |
| | | list of the restricted authorization scopes |
| | | associated with the access token. NOTE: The |
| | | scope is open to all restricted services, but |
| | | this document only includes the restricted |
| | | scope as Security context transfer. |
| NF | Required | The identifier of the NF consumer making |
| consumer_ID | | the request for token. NOTE: This parameter |
| | | is used to identify the AMF which will be |
| | | requesting for the security context from |
| | | the other AMF. |

NOTE:
The claims are not restricted to above described parameters.

Step 12: On receiving access token(s), the target AMF (400) sends a Namf_Communication_UEContextTransfer Request, or to the restricted service and/or operation as indicated by access token, to the initial AMF (300). The initial AMF (300) being pre-provisioned with the tokens performs a token validation with the pre-provisioned token or with the NRF (600)/AF/AUSF or UDM (700). On successful validation of tokens, the initial AMF (300) sends the security context in possession (which is also in possession with the UE) to the target AMF (400) in the Namf_Communication_Rsestricted response message.

In an embodiment, the target AMF (400) indicates or sets the permission as READ ONLY. Therefore, the initial AMF (300) is only allowed to provide the security context to the target AMF (400) avoiding the force writing of security context to the target AMF (400).

Alternatively, step 11 can be performed before step 10. Step 13: With the received security context the target AMF (400) sends the protected NAS message and the UE (100) being in possession with the same security context is able to process the NAS messages from the target AMF (400).

To protect against leakage or other compromise, access token lifetimes are typically short lived. Some access tokens can be issued longer-lived refresh tokens, which enable them to refresh the access token and avoid having to prompt the user for authentication again when the access token expires. Refresh tokens are available only to AMF utilizing the authorization code.

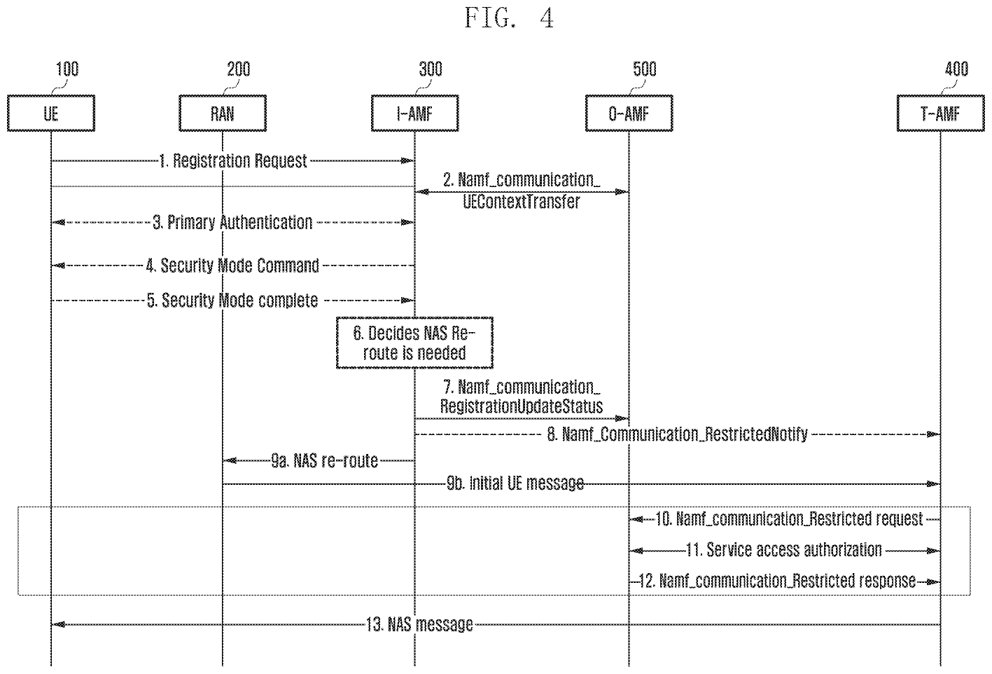

FIG. 4 illustrates the procedure in which the target AMF (400) requests for a restricted service access from the old AMF (500) in case of mobility registration, wherein the old AMF (500) authorizes the target AMF (400) before sending the restricted services parameters in the response message.

Step 1: The UE (100) sends a registration request with a SUCI or 5G-GUTI.

Step 2: Since it is a mobility registration the initial AMF (300) gets the security context from the old AMF (500).

Step 3: If it is an initial registration, the initial AMF (300) initiates primary authentication. The initial AMF (300) performs a round of primary authentication with the UE (100) to establish new security context. In an embodiment, in order for the iAMF (300) to determine if there is an AMF re-allocation, the iAMF (300) needs to establish security with the UE (100) and the UE (100) needs to send the complete Registration Request including the protected IEs (such as the NSSAI) to the iAMF (300).

Step 4: The initial AMF (300) sends a security mode command (SMC) message if decides to take into use the new security context resulted from the successful authentication.

Step 5: The UE (100) processes the security mode command (SMC) message and returns a security mode complete message.

Step 6: The initial AMF (300) determines the need of AMF re-allocation, finds the suitable target AMF (400) to be re-allocated to and decides to initiate NAS rerouting based on local policy and subscription information.

Step 7: If step 2 is not performed, this step is skipped. Otherwise, the initial AMF (300) notifies the old AMF (500) that the registration is not successful. The old AMF (500) continues as if the Namf_Communication_UEContextTransfer in step 2 had never been received.

Step 8: (Optional) The initial AMF (300) notifies the target AMF (400) as well as the old AMF (500) about the restricted service access.

Step 9a: If the UE (100) and the initial AMF (300) have activated security context, the initial AMF sends a NAS re-route message to the RAN (200) with indication of AMF re-allocation.

In an embodiment, along with the indication the initial AMF (300) may include the AMF ID (which identifies the initial AMF).

In an embodiment, the initial AMF (300) sends an indication of NAS re-route to the UE (100) in a NAS message. This indication is sent in order to notify the UE (100) about the decision of NAS re-route.

Step 9b: The RAN (200) re-routes the initial UE message to the appropriate target AMF (400).

Step 10: On receiving the initial registration request via NAS re-route, the target AMF (400) requests for the restricted service from the old AMF (500) in a service based message, Namf_communication_Restricted request.

Step 11: The target AMF (400) sends a service access request to an OAuth Server, the Network Repository Function entity (600) (as defined in clause 5.7)/Trusted 3rd Party Application Function (as defined in clause 5.8)/Authentication Server Function or UDM (as defined in clause 5.7) which acts as a token issuer for the restricted access service.

In case the OAuth Server is a trusted 3rd party entity, it is assumed that there is a mutual authentication between AMF and AF before the exchange of any tokens.

In an embodiment, the target AMF (400) constructs the request for service access may include the parameters, as depicted in Table 8.

TABLE 8

| Parameter | Presence | Values |
|---|---|---|
| Ser- | RE- | For the AMF re-allocation purpose the service |
| vice_type | QUIRED | type is set as: “AMF-Relloc: RestrictedAccess”, |
| | | which indicates about the restricted service |
| | | for which the access token is requested for. |
| NF | RE- | The identifier of the AMF making the request to |
| Consumer | QUIRED | which the AF will redirect the service access |
| ID | | response in order to return the authorization code. |
| Scope | RE- | Scope values are expressed as a list of space- |
| | QUIRED | delimited, case-sensitive strings which indicate |
| | | which indicates about the restricted service. If |
| | | authorized, the requested scope values will be |
| | | bound to the access token returned to the NF |
| | | consumer (target AMF in this case). |
| NF | OP- | The identifier of the AMF from which the |
| Producer | TIONAL | restricted service access will be requested. |
| ID | | |

Alternatively, upon receiving initial registration request via NAS re-route, target AMF (400) first determines which services are supported by the initial AMF (300) by querying the NRF (600). It then sends a service-access request to authorization server requesting access to initial AMF's services which provide UE context transfer service.

On successful authorization check, the NRF (600)/AF/AUSF or UDM (700) provides an access token and ServID token scoped only for getting the restricted service (security context) from the initial AMF (300).

Alternatively, based on the information about the target AMF (400) received during Access Token Request in Step 10, the NRF (600) determines that it is only allowed to access restricted services on the initial AMF (300). Accordingly, it returns an access token with scope limited to restricted services only, irrespective of what was requested in the request.

In an embodiment, there is only one access token generated scope of which also helps to identify the restricted service.

In another embodiment, the NRF (600)/AF/AUSF or UDM (700) generates two tokens, one access token scoped only for identification of NF consumer and another service token (ServID Token) scoped to identify the restricted service for which the access token is being issued.

Access Token is used to get the security context from the initial AMF (300). ServID Token is associated with Access token, it helps to associate with the AMF from which the context is being requested.

In an embodiment, the core network provides only one access token which is used by the NF consumer encoded as a JSON Web Token.

In an embodiment, the access token provided by OAuth Server allows access to only the restricted service(s) and/or restricted service operation(s).

Table 9 illustrates the claims conveyed using the access token.

TABLE 9

| Parameter | Presence | Description |
|---|---|---|
| Exp | Required | Expiry time of token |
| Scope | Required | A JSON string containing a space-separated |
| | | list of the restricted authorization scopes |
| | | associated with the access token. NOTE: The |
| | | scope is open to all restricted services, but |
| | | this document only includes the restricted |
| | | scope as Security context transfer. |
| NF | Required | The identifier of the NF consumer making |
| consumer_ID | | the request for token. NOTE: This parameter |
| | | is used to identify the AMF which will be |
| | | requesting for the security context from |
| | | the other AMF. |

NOTE:
The claims are not restricted to above described parameters.

In another embodiment, the core network issues two tokens, one access token scoped only for identification of NF consumer and another service token (ServID Token) scoped to identify the restricted service for which the access token is being issued.

Step 12: On receiving access token(s), the target AMF (400) sends a Namf_Communication_UEContextTransfer Request, or to the restricted service and/or operation as indicated by access token, to the old AMF (500). The old AMF (500) being pre-provisioned with the tokens performs a token validation with the pre-provisioned token or with NRF (600)/AF/AUSF or UDM (700). On successful validation of tokens, the old AMF (500) sends the security context in possession (which is also in possession with the UE) to the target AMF (400) in Namf_Communication_Rsestricted response message.

In an embodiment, the target AMF (400) indicates or sets the permission as READ ONLY. Therefore, the old AMF (500) is only allowed to provide the security context to the target AMF (400) avoiding the force writing of security context to the target AMF (400).

Alternatively, step 11 can be performed before step 10. Step 13: With the received security context the target AMF (400) sends the protected NAS message and the UE (100) being in possession with the same security context is able to process the NAS messages from target AMF (400).

To protect against leakage or other compromise, access token lifetimes are typically short lived. Some access tokens can be issued longer-lived refresh tokens, which enable them to refresh the access token and avoid having to prompt the user for authentication again when the access token expires. Refresh tokens are available only to AMF utilizing the authorization code.

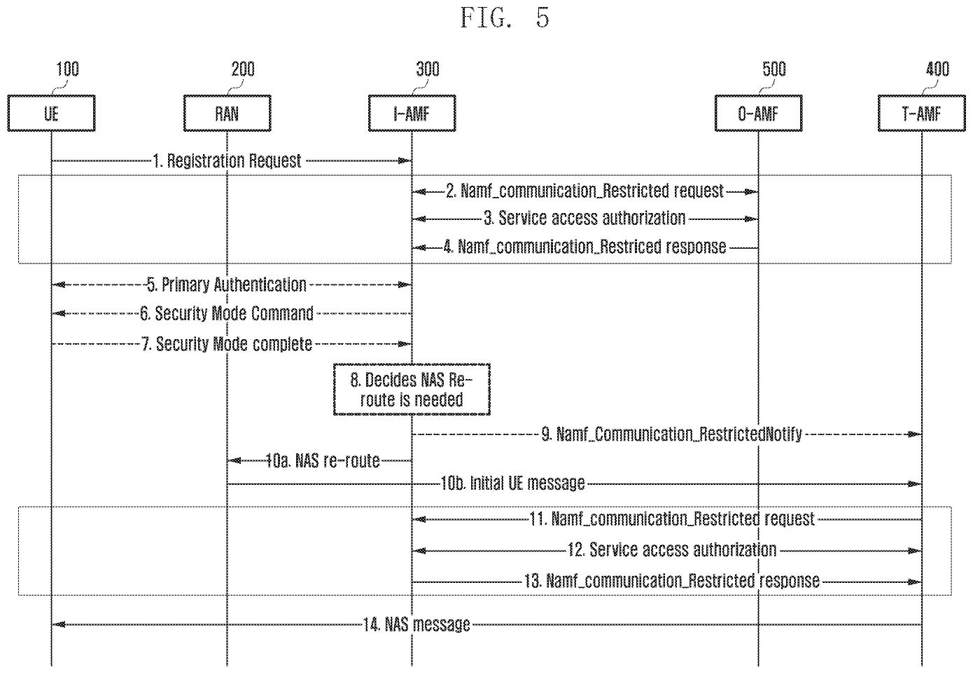

FIG. 5 illustrates the procedure in which the target AMF (400) requests for the restricted service access from the initial AMF (300) in case of mobility registration, wherein the initial AMF (300) authorizes the target AMF (400) before sending the restricted services parameters in the response message.

Step 1: The UE (100) sends a registration request with a SUCI or 5G-GUTI.

Step 2: Since it is a mobility registration, the initial AMF (300) gets the security context from the old AMF (500).

The initial AMF (300) requests for the restricted service from the old AMF (500) in a service-based message, Namf_communication_Restricted request.

Step 3: The initial AMF (300) sends a service access request to an OAuth Server, the Network Repository Function entity (600) (as defined in clause 5.7)/Trusted 3 rd Party Application Function (as defined in clause 5.8)/Authentication Server Function or UDM (as defined in clause 5.7) which acts as a token issuer for the restricted access service. In case, the OAuth Server is a trusted 3rd party entity, it is assumed that there is a mutual authentication between AMF and AF before the exchange of any tokens.

In an embodiment, the initial AMF (300) constructs the request for service access may include the parameters, as illustrated in Table 10.

TABLE 10

| Parameter | Presence | Values |
|---|---|---|
| Ser- | RE- | For the AMF re-allocation purpose the service |
| vice_type | QUIRED | type is set as: “AMF-Relloc: RestrictedAccess”, |
| | | which indicates about the restricted service |
| | | for which the access token is requested for. |
| NF | RE- | The identifier of the AMF making the request to |
| Consumer | QUIRED | which the AF will redirect the service access |
| ID | | response in order to return the authorization code. |
| Scope | RE- | Scope values are expressed as a list of space- |
| | QUIRED | delimited, case-sensitive strings which indicate |
| | | which indicates about the restricted service. If |
| | | authorized, the requested scope values will be |
| | | bound to the access token returned to the NF |
| | | consumer (target AMF in this case). |
| NF | OP- | The identifier of the AMF from which the |
| Producer | TIONAL | restricted service access will be requested. |
| ID | | |

Alternatively, the initial AMF (300) first determines which services are supported by the old AMF (500) by querying the NRF (600). It then sends a service-access request to authorization server requesting access to the old AMF's services which provide UE context transfer service.

On successful authorization check, the NRF (600)/AF/AUSF or UDM (700) provides an access token and ServID token scoped only for getting the restricted service (security context) from the old AMF (500).

Alternatively, based on the information about initial AMF (300) received during Access Token Request in Step 2, the NRF (600) determines that it is only allowed to access restricted services on the old AMF (500). Accordingly, it returns an access token with scope limited to restricted services only, irrespective of what was requested in the request.

In an embodiment, there is only one access token generated scope of which also helps to identify the restricted service.

In another embodiment, the NRF (600)/AF/AUSF or UDM (700) generates two tokens, one access token scoped only for identification of NF consumer and another service token (ServID Token) scoped to identify the restricted service for which the access token is being issued.

The Access Token is used to get the security context from the old AMF (500). The ServID Token is associated with the access token, it helps to associate with the AMF from which the context is being requested.

In an embodiment, the core network provides only one access token which is used by the NF consumer encoded as a JSON Web Token.

In an embodiment, the access token provided by OAuth Server allows access to only the restricted service(s) and/or restricted service operation(s).

Table 11 illustrates the claims conveyed using the access token.

TABLE 11

| Parameter | Presence | Description |
|---|---|---|
| Exp | Required | Expiry time of token |
| Scope | Required | A JSON string containing a space-separated |
| | | list of the restricted authorization scopes |
| | | associated with the access token. NOTE: The |
| | | scope is open to all restricted services, but |
| | | this document only includes the restricted |
| | | scope as Security context transfer. |
| NF | Required | The identifier of the NF consumer making |
| consumer_ID | | the request for token. NOTE: This parameter |
| | | is used to identify the AMF which will be |
| | | requesting for the security context from |
| | | the other AMF. |

NOTE:
The claims are not restricted to above described parameters.

In another embodiment, the core network issues two tokens, one access token scoped only for identification of NF consumer and another service token (ServID Token) scoped to identify the restricted service for which the access token is being issued.

Step 4: On receiving access token(s), the initial AMF (300) sends a Namf_Communication_UEContextTransfer Request, or to the restricted service and/or operation as indicated by access token, to the old AMF (500). The old AMF (500) being pre-provisioned with the tokens performs a token validation with the pre-provisioned token or with the NRF (600)/AF/AUSF or UDM (700). On successful validation of tokens, the old AMF (500) sends the security context in possession (which is also in possession with the UE) to the initial AMF (300) in Namf_Communication_Rsestricted response message.

In an embodiment, the initial AMF (300) indicates or sets the permission as READ ONLY mode. Therefore, the old AMF (500) is only allowed to provide the security context to the initial AMF (300) avoiding the force writing of security context to the target AMF (400).

Alternatively, step 3 can be performed before step 2.

Step 5: If it is an initial registration, the initial AMF (300) initiates primary authentication. The initial AMF (300) performs a round of primary authentication with the UE (100) to establish new security context.

In an embodiment, in order for the iAMF (300) to determine if there is an AMF re-allocation, the iAMF (300) needs to establish security with the UE (100) and the UE (100) needs to send the complete Registration Request including the protected IEs (such as the NSSAI) to the iAMF (300).

Step 6: The initial AMF (300) sends a security mode command (SMC) message if decides to take into use the new security context resulted from the successful authentication.

Step 7: the UE (100) processes the security mode command (SMC) message and returns a security mode complete message.

Step 8: The initial AMF (300) determines the need of AMF re-allocation, finds the suitable target AMF (400) to be re-allocated to and decides to initiate NAS rerouting based on local policy and subscription information.

Step 9: (Optional) The initial AMF (300) notifies the target AMF (400) as well as the old AMF (500) about the restricted service access.

Step 10a: If the UE (100) and the initial AMF (300) have activated security context, the initial AMF (300) sends a NAS re-route message to the RAN (200) with indication of AMF re-allocation.

In an embodiment, along with the indication the initial AMF (300) may include the AMF ID (which identifies the initial AMF).

In an embodiment, the initial AMF (300) sends an indication of NAS re-route to the UE (100) in a NAS message. This indication is sent in order to notify the UE about the decision of NAS re-route.

Step 10b: The RAN (200) re-routes the initial UE message to the appropriate target AMF (400).

Steps 11-13: The target AMF (400) on receiving the initial UE message perform steps 2-4 with either initial AMF (300) or the old AMF (500) and gets the security context.

Step 13: With the received security context the target AMF (400) sends the protected NAS message and UE (100) being in possession with the same security context is able to process the NAS messages from target AMF (400).

To protect against leakage or other compromise, access token lifetimes are typically short lived. Some access tokens can be issued longer-lived refresh tokens, which enable them to refresh the access token and avoid having to prompt the user for authentication again when the access token expires. Refresh tokens are available only to AMF utilizing the authorization code.

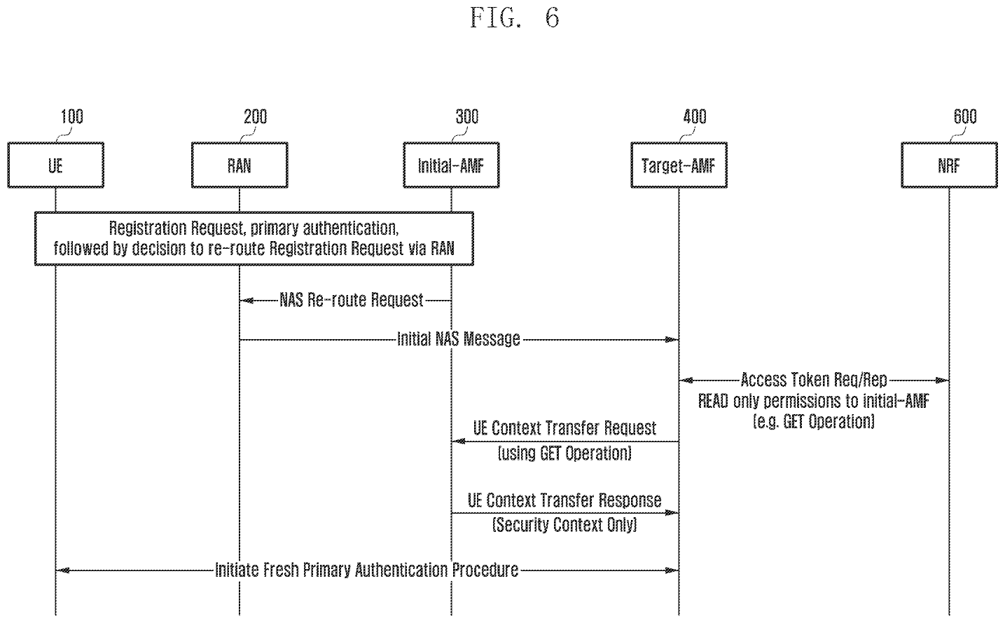

FIG. 6 illustrates the procedure in which the target AMF (400) requests for the restricted service access from initial AMF (300) in case of mobility registration, wherein the initial AMF (300) authorizes the target AMF (400) before sending the restricted services parameters in the response message.

In an embodiment, when the initial AMF (300) re-routes registration via the RAN (200), it includes the AMF-ID which allows the target AMF (400) identify the initial-AMF (300). In an embodiment, the AMFs in isolated slice receive only read permission to access each other. That is, when the target AMF (400) requests the NRF (600) to provide Access-Token to access the initial-AMF (300), it is provided with only read access to the initial-AMF (300). In an embodiment, the AMFs support transferring the UE context via an HTTP GET operation, as opposed to the POST method currently, which is a write operation. In an embodiment, the AMFs define scope to limit the amount of information that can be shared among the isolated AMFs. This can be limited to, e.g., transfer only the security context between the AMFs. In an embodiment, the target AMF (400) uses the security context transferred from the old AMF (500) only to be able to start communication with the UE. In order to ensure the UE's identity, it performs fresh primary authentication procedure post context transfer from the initial AMF (300).

Step 1: the UE (100) sends the registration request to the initial-AMF (300). The primary authentication takes places and the initial-AMF (300) determines that the target-AMF (400) is best suited to serve the UE's service requirements. Decision to reroute the registration request via the RAN (200) takes places.

Step 2: The initial-AMF (300) sends the complete registration request received from the UE (100) to the RAN (200), requesting it to re-route it to the target-AMF (400). The initial-AMF (300) includes it's AMF-ID in the reroute request.

Step 3: The registration request is rerouted to the target-AMF (400).

Step 4: The target-AMF (400) requests the NRF (600) to grant access-token to access the initial-AMF (300). Based on its local configuration, and/or NF profiles registered by both initial-AMF (300) and the target-AMF (400) in the NRF (600), the NRF (600) determines that the target-AMF is not allowed to access the initial-AMF (300). Based on the embodiments in this document, it provides the target-AMF (400) the restricted access to the initial-AMF (300), e.g. read-only permissions, and/or access to limited data as defined in clause “Restricted Service”. In an example, the information is limited to only the security context.

Steps 5 and 6: the target-AMF (400) retrieves UE's security context from the initial-AMF (300).

Step 7: the target-AMF (400) sends/initiates fresh primary authentication procedure.

In an embodiment, the UE security context transfer when required between the initial AMF (300) and the target AMF (400), the target AMF (400) requests for the restricted service access from the initial AMF (300) in case of mobility registration, wherein the initial AMF (300) authorizes the target AMF (400) before sending the restricted service parameters in the response message.

The target-AMF (400) requests the NRF (600) to grant access-token to access the initial-AMF (300). Based on its local configuration, and/or NF profiles registered by both initial-AMF (300) and the target-AMF (400) in the NRF (600), the NRF (600) determines that the target-AMF is not allowed to access the initial-AMF (300). In the embodiments, it provides the target-AMF (400) the restricted access to the initial-AMF (300), e.g. read-only permissions, and/or access to limited data as defined in clause “Restricted Service”. In an example, the information is limited to only the security context.

In an embodiment, when the target AMF (400) receives the access token, it includes the received access token in the restricted UE security context request based on the embodiments.

In an embodiment, the initial AMF (300) limits the amount of information that can be shared with the target AMF (400) (e.g., transfer only the security context between the AMFs.) based on the scope claimed in the access token.

In an example embodiment, for the UE-to-Network relay communication in the Proximity services remote AMF is the initial AMF and relay AMF is the target AMF. When the remote UE has established the relay connectivity and/or is trying for subsequent connection or when the remote UE pre-establishes context with the network and derives the Proximity Service specific security context and stores the security context at the remote AMF. The relay AMF sends a restricted UE security context transfer request to fetch the Proximity service related security context from the remote AMF. If authorized, the remote AMF sends only the Proximity Service related security context in response to the restricted UE security context request. The remote AMF does not send the SMF information, PDU session ID or other parameters which are not scoped to be shared.

Authorization Framework:

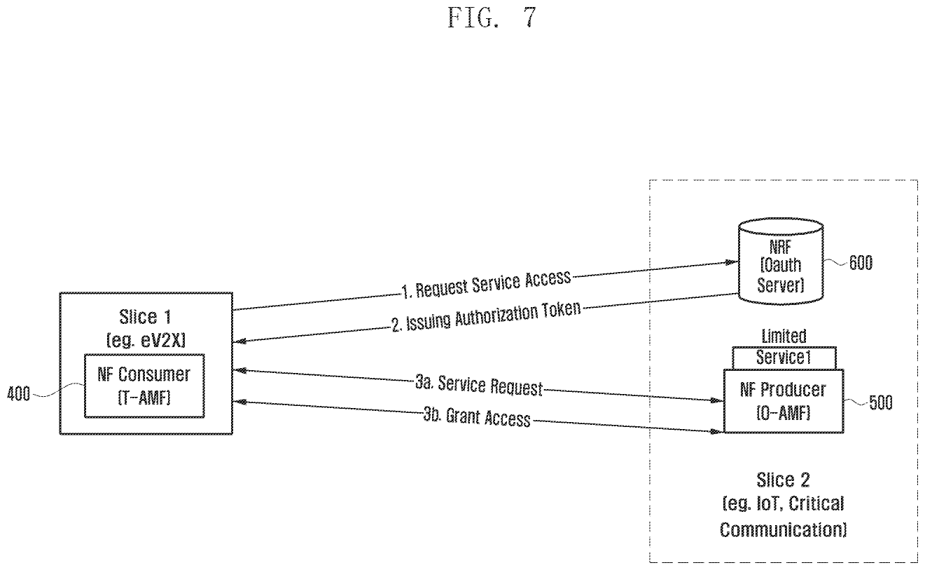

FIG. 7 illustrates the procedure of OAuth framework where the NRF (600) acts as the OAuth Server used for getting the access token by the consumer NF to get the security context from the NF Producer. In an embodiment, step 1, the NF consumer sends the request service access to the NRF (600) and step 2, the NF consumer obtain the access token and a ServID_Token from the NRF (600). This access token is used to get the security context from the initial AMF (300) or the old AMF (500). The ServID_Token is associated with the access token and it helps to associate with the AMF from which the context is being requested.

In an embodiment, the core network provides only one access token which is used by the NF consumer encoded as the JSON Web Token. In an embodiment, the access token provided by authorization server allows access to only the restricted service(s) and/or restricted service operation(s).

Table 12 illustrates the claims conveyed using the access token.

TABLE 12

| Parameter | Presence | Description |
|---|---|---|
| Exp | Required | Expiry time of token |
| Scope | Required | A JSON string containing a space-separated |
| | | list of the restricted authorization scopes |
| | | associated with the access token. NOTE: The |
| | | scope is open to all restricted services, but |
| | | this document only includes the restricted |
| | | scope as Security context transfer. |
| NF | Required | The identifier of the NF consumer making |
| consumer_ID | | the request for token. NOTE: This parameter |
| | | is used to identify the AMF which will be |
| | | requesting for the security context from |
| | | the other AMF. |

NOTE:
The claims are not restricted to above described parameters.

In another embodiment, the core network issues two tokens, one access token scoped only for identification of NF consumer and another service token (ServID Token) scoped to identify the restricted service for which the access token is being issued.

Step 3a, the NF consumer sends a service request including the access token to the NF producer and step 3b, the grant access is provided between the NF consumer and the NF producer. In an embodiment, step 3a-3b is performed over N14 interface or via a well-connected node.

In another embodiment, it is proposed to have a different interface say N14′ which serves for only restricted service access as defined in the description of the restricted service (as disclosed above).

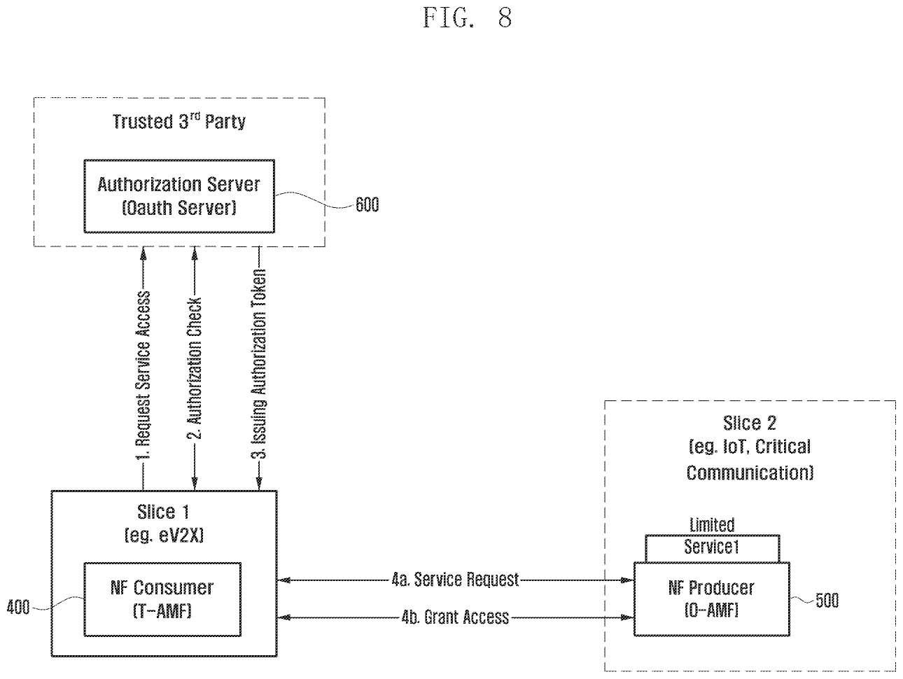

FIG. 8 illustrates the procedure of OAuth framework where trusted AF acts as the OAuth Server used for getting the access token by the consumer NF to get the security context from NF Producer. In an embodiment, in the authorization framework shown above, the NF consumer obtains the access token and a ServID_Token from the trusted 3 rd party AF. This access token is used to get the security context from the initial AMF (300) or the old AMF (500). ServID_Token is associated with Access token; it helps to associate with the AMF from which the context is being requested.

Referring to the FIG. 8, in an embodiment, step 1, the NF consumer sends the request service access to the authorization server. Step 2, the authorization check is determined between the NF consumer and the authorization server. Step 3, the NF consumer obtains the access token and a ServID_Token from the authorization server. Step 4a, the NF consumer sends a service request including the access token to the NF producer and step 4b, the grant access is provided between the NF consumer and the NF producer.

In an embodiment, the core network provides only one access token which is used by the NF consumer encoded as the JSON Web Token.

In an embodiment, the access token provided by authorization server allows access to only the restricted service(s) and/or restricted service operation(s).

Table 13 illustrates the claims conveyed using the access token:

TABLE 13

| Parameter | Presence | Description |
|---|---|---|
| Exp | Required | Expiry time of token |
| Scope | Required | A JSON string containing a space-separated |
| | | list of the restricted authorization scopes |
| | | associated with the access token. NOTE: The |
| | | scope is open to all restricted services, but |
| | | this document only includes the restricted |
| | | scope as Security context transfer. |
| NF | Required | The identifier of the NF consumer making |
| consumer_ID | | the request for token. NOTE: This parameter |
| | | is used to identify the AMF which will be |
| | | requesting for the security context from |
| | | the other AMF. |

NOTE:
The claims are not restricted to above described parameters.

In another embodiment, the core network issues two tokens, one access token scoped only for identification of the NF consumer and another service token (ServID_Token) scoped to identify the restricted service for which the access token is being issued.

In an embodiment, steps 4a-4b are performed over N14 interface or via a well-connected node.

In another embodiment, it is proposed to have a different interface say N14′ which serves for only restricted service access, as defined in the description of the restricted service (as disclosed above).

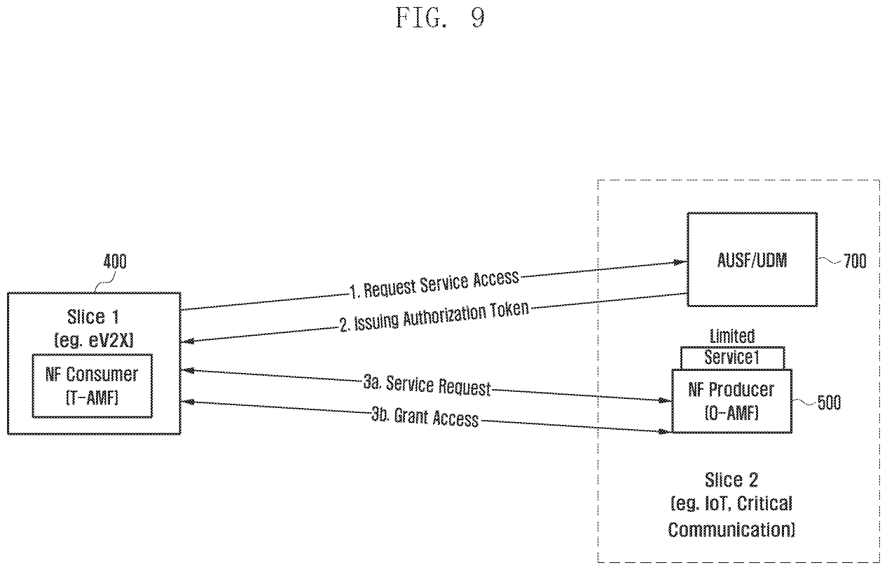

FIG. 9 illustrates the procedure of OAuth framework where AUSF/UDM (700) acts as the OAuth Server used for getting the access token by the consumer NF to get the security context from the NF Producer.

In an embodiment, in the authorization framework shown above, the NF consumer obtains an Access token and a ServID_Token from the AUSF/UDM (700). This Access Token is used to get the security context from the initial AMF (300) or the old AMF (500). ServID Token is associated with Access token; it helps to associate with the AMF from which the context is being requested.

In an embodiment, the core network provides only one access token which is used by the NF consumer encoded as a JSON Web Token.

In an embodiment, the access token provided by authorization server allows access to only the restricted service(s) and/or restricted service operation(s).

Table 14 illustrates the claims conveyed using the access token.

TABLE 14

| Parameter | Presence | Description |
|---|---|---|
| Exp | Required | Expiry time of token |
| Scope | Required | A JSON string containing a space-separated |
| | | list of the restricted authorization scopes |
| | | associated with the access token. NOTE: The |
| | | scope is open to all restricted services, but |
| | | this document only includes the restricted |
| | | scope as Security context transfer. |
| NF | Required | The identifier of the NF consumer making |
| consumer_ID | | the request for token. NOTE: This parameter |
| | | is used to identify the AMF which will be |
| | | requesting for the security context from |
| | | the other AMF. |

NOTE:
The claims are not restricted to above described parameters.

In another embodiment, the core network issues two tokens, one access token scoped only for identification of NF consumer and another service token (ServID Token) scoped to identify the restricted service for which the access token is being issued.

In an embodiment, steps 3a-3b are performed over N14 interface or via a well-connected node.

In another embodiment, it is proposed to have a different interface say N14′ which serves for only restricted service access, as defined in the description of the restricted service (as disclosed above).

As shown in the FIG. 9, in an embodiment, step 1, the NF consumer sends the request service access to the AUSF/UDM (700). Step 2, the NF consumer obtains the access token and a ServID Token from the AUSF/UDM (700). Step 3a, the NF consumer sends a service request including the access token to the NF producer and step 3b, the grant access is provided between the NF consumer and the NF producer.

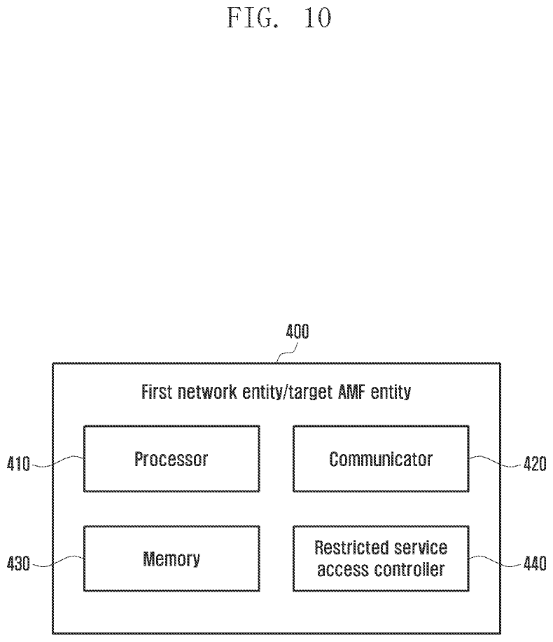

FIG. 10 shows various hardware components of the first network entity (400), according to embodiments as disclosed herein. In an embodiment, the first network entity (400) includes a processor (410), a communicator (420), a memory (430) and a restricted service access controller (440). The processor (410) is coupled with the communicator (420), the memory (430), and the restricted service access controller (440).

The first network entity (400) requests for the restricted service access from the second network entity (300) in the mobility registration scenario. The first network entity (400) can be the target AMF entity (400) and the second network entity (300) can be the initial AMF entity (300).

In an embodiment, the restricted service access controller (440) is configured to request the NRF entity (600) to grant the access-token to access the second network entity (300). The NRF entity (600) generates the access token scope for the restricted security context transfer between the first network entity (400) and the second network entity (300). The access token scope restricts the permission granularity, and the scope associated with the first network entity (400) indicates the permission as READ only to avoid force writing of security context to the first network entity (400). Based on the access-token, the restricted service access controller (440) is configured to receive the message comprising the restricted service access to the second network entity (300). The restricted service access can be, for example, but not limited to the UE context transfer access, the registration status update access, and the create UE context access.

Based on the message comprising the restricted service access, the restricted service access controller (440) is configured to send the UE context transfer request to the second network entity (300). Based on the UE context transfer request, the restricted service access controller (440) is configured to receive the UE context transfer response from the second network entity (300).

The restricted service access controller (440) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. However, the term “non-transitory” should not be interpreted that the memory (430) is non-movable. In certain examples, a non-transitory storage medium may store data that can, over time, change (e.g., in Random Access Memory (RAM) or cache).

Further, at least one of the pluralities of modules/controller may be implemented through the AI model using a data driven controller (not shown). The data driven controller can be a ML model based controller and AI model based controller. A function associated with the AI model may be performed through the non-volatile memory, the volatile memory, and the processor (410). The processor (410) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 10 shows various hardware components of the first network entity (100) but it is to be understood that other embodiments are not limited thereon. In other embodiments, the first network entity (100) may include less or more number of components. Further, the labels or names of the components are used only for illustrative purpose and does not limit the scope of the invention. One or more components can be combined together to perform same or substantially similar function in the first network entity (100).

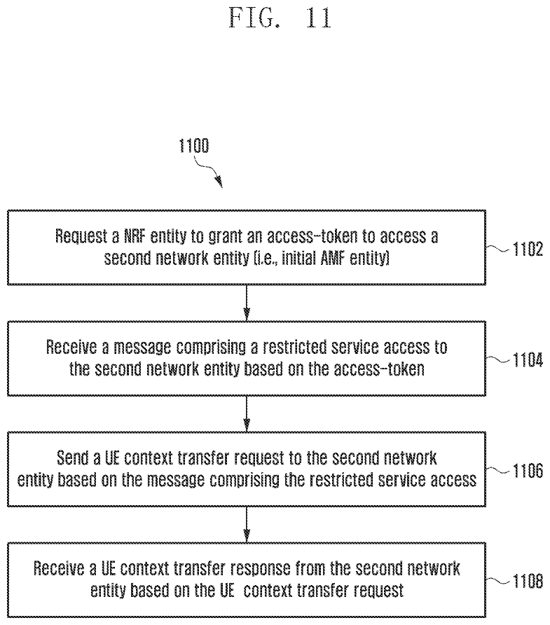

FIG. 11 is a flow chart (1100) illustrating a method for providing restricted service access in the wireless network (e.g., 5G network), according to embodiments as disclosed herein. The operations (1102-1108) are performed by the restricted service access controller (440). At 1102, the method includes requesting the NRF entity (600) to grant the access-token to access the second network entity (e.g. initial AMF entity (300)). At 1104, the method includes receiving the message comprising the restricted service access to the second network entity based on the access-token. At 1106, the method includes sending the restricted UE context transfer request to the second network entity based on the message comprising the restricted service access. At 1108, the method includes receiving the UE context transfer response from the second network entity based on the restricted UE context transfer request.

The proposed method can also be implemented in a 6G network and an O-RAN network.

The various actions, acts, blocks, steps, or the like in the flow chart (1100) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

1. A method for providing restricted service access in a wireless network, the method comprising:
sending, by a first network entity, a request to a Network Repository Function entity to grant an access-token to access a second network entity;
receiving, by the first network entity, a message comprising a restricted service access to the second network entity based on the access-token;
sending, by the first network entity, a restricted User Equipment context transfer request to the second network entity based on the message comprising the restricted service access; and
receiving, by the first network entity, a UE context transfer response from the second network entity based on the restricted UE context transfer request.

2. The method of claim 1, wherein the restricted service access comprises at least one of a UE context transfer access, a registration status update access, and a create UE context access.

3. The method of claim 1, wherein the first network entity requests for the restricted service access from the second network entity in a mobility registration scenario.

4. The method of claim 1, wherein the first network entity is a target AMF entity and the second network entity is an initial AMF entity.

5. The method of claim 1, wherein the NRF entity generates an access token scope for restricted security context transfer between the first network entity and the second network entity.

6. The method of claim 5, wherein the access token scope restricts a permission granularity, and a scope associated with the first network entity indicates a permission as READ only to avoid force writing of security context to the first network entity.

7. A first network entity for providing restricted service access in a wireless network, the first network device entity comprising:
a processor;
a memory; and
a restricted service access controller, coupled with the processor and the memory, configured to:
send a request to a Network Repository Function entity to grant an access-token to access a second network entity;
receive a message comprising a restricted service access to the second network entity based on the access-token;
send a User Equipment context transfer request to the second network entity based on the message comprising the restricted service access; and
receive a UE context transfer response from the second network entity based on the UE context transfer request.

8. The first network entity of claim 7, wherein the restricted service access comprises at least one of a UE context transfer access, a registration status update access, and a create UE context access.

9. The first network entity of claim 7, wherein the first network entity requests for the restricted service access from the second network entity in a mobility registration scenario.

10. The first network entity of claim 7, wherein the first network entity is a target AMF entity and the second network entity is an initial AMF entity.

11. The first network entity of claim 7, wherein the NRF entity generates an access token scope for the restricted security context transfer between the first network entity and the second network entity.

12. The first network entity of claim 11, wherein the access token scope restricts a permission granularity, and a scope associated with the first network entity indicates a permission as READ only to avoid force writing of security context to the first network entity.
